(19) United States
(12) Patent Application Publication
(10) Pub. No.: US 2003/0084139 A1
(43) Pub. Date: May 1, 2003

(54) Method and apparatus for brokering of control instructions for an intelligent device

(75) Inventors: Wyatt Allen Huddleston, Phoenix, AZ (US); David John Schwartz, Scottsdale, AZ (US); Steven Wojnowski, Hoffman Estates, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/045,724

(22) Filed: Oct. 26, 2001

(51) Int. Cl. G06F 15/16; G06F 15/173

(52) U.S. Cl. 709/223; 709/230

(57) ABSTRACT

A web site (110) is arranged (502) to have access to control instructions (414) for an intelligent device (112), and a desired function to be performed by the intelligent device is defined (504) in a wireless internet access device (WIAD) (102). The WIAD identifies (506) the intelligent device and the desired function to the web site through a wireless communication network (104), and the web site returns (508) to the WIAD a subset (316) of the control instructions for controlling the intelligent device to perform the desired function. The WIAD then forwards (510) the subset of the control instructions to the intelligent device to effect the desired function.

### FIELD OF THE INVENTION

This invention relates in general to data communication systems, and more specifically to a method and apparatus for brokering of control instructions for an intelligent device.

### BACKGROUND OF THE INVENTION

Intelligent devices are increasing in popularity throughout the world. Such devices can include kitchen appliances, automobiles, temperature controllers, celestial telescopes, VCRs, lighting, and computer peripherals, to name a few. As more features are added, some intelligent devices can become difficult for users to setup and control. Furthermore, different intelligent devices generally require completely different sets of control instructions to effect essentially identical functions. For example, the remote control commands for different brands of video cassette recorders are unique to each brand. A portable device that could be pre-programmed with all possible sets of control instructions for all possible intelligent devices would require an enormous amount of memory. In addition, such a device would become obsolete quickly as new intelligent devices become available.

Thus, what is needed is a method and apparatus for brokering of or providing control instructions for or to an intelligent device. Preferably, the method and apparatus will simplify setup and control of intelligent devices by a user. In addition, the method and apparatus will require little memory and will provide for automatic updating of control instructions as new intelligent devices become available on the market.

### BRIEF DESCRIPTION OF THE DRAWINGS

Additional objects and advantages of the present invention will be more readily apparent from the following detailed description of preferred embodiments thereof when taken together with the accompanying drawings in which:

FIG. 1 is an electrical block diagram of an exemplary communication network in accordance with the present invention;

FIG. 2 is an electrical block diagram of an exemplary intelligent device in accordance with the present invention;

FIG. 3 is an electrical block diagram of an exemplary wireless internet access device in accordance with the present invention;

FIG. 4 is an electrical block diagram of an exemplary web site in accordance with the present invention; and

FIG. 5 is a flow diagram depicting operation of the exemplary communication network in accordance with the present invention.

### DETAILED DESCRIPTION OF THE DRAWINGS

In overview form the present disclosure concerns communications networks suitable for brokering or making available control instructions that can be updated as required for intelligent devices or equipment. As further discussed below various inventive principles and combinations thereof are advantageously employed to broker or make available control instructions for intelligent devices provided these principles or equivalents are utilized.

The instant disclosure is provided to explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items, or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

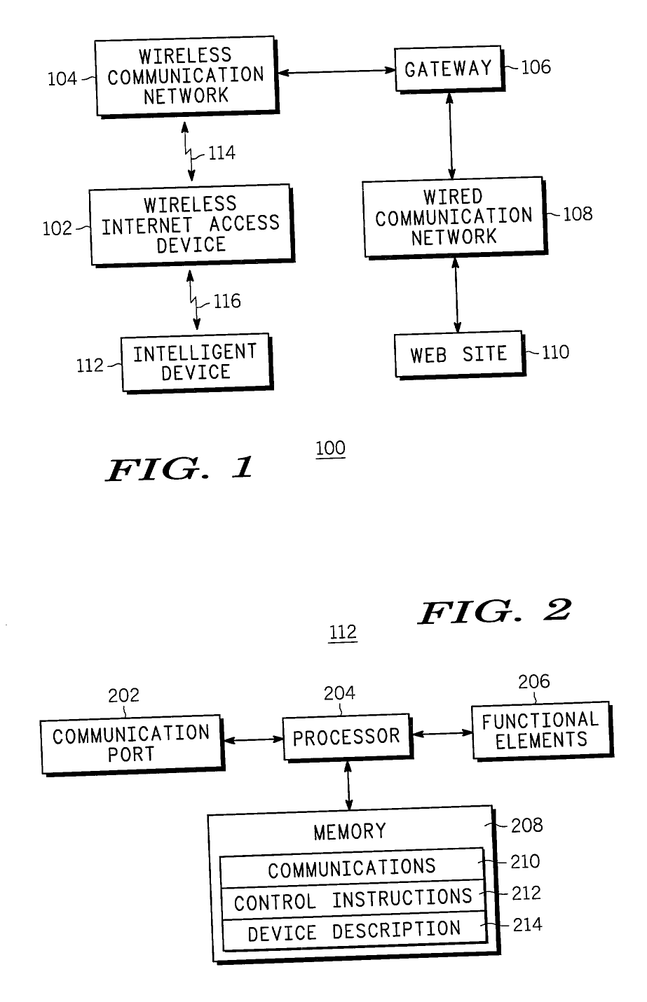

The present disclosure will discuss various embodiments in accordance with the invention. The system diagram of FIG. 1 will be used to lay the groundwork for a deeper understanding of the present invention and advantages thereof. FIG. 1 in large part and at the simplified level depicted is a representative diagram of a communications network 100 and will serve to explain the problems and certain inventive solutions thereto according to the present invention.

Referring to FIG. 1, an electrical block diagram of an exemplary communication network 100 in accordance with the present invention comprises a wireless internet access device (WIAD) 102 for defining a desired function to be performed by an intelligent device 112. The WIAD 102 can, for example, be a cellular handset compatible with the well-known Wireless Access Protocol (WAP), a wireless personal digital assistant (PDA), or a laptop computer having wireless network access, to name a few. The WIAD 102 is coupled through a first conventional communication link 114 to a conventional wireless communication network 104, e.g., a cellular telephone network, preferably coupled through a conventional gateway 106 to a conventional wired communication network 108, e.g., the Internet. A web site 110 in accordance with the present invention is coupled to the wired communication network 108. In addition, the network 100 includes the intelligent device 112 coupled through a second conventional communication link 116 to the WIAD 102. The second conventional communication link 116 preferably utilizes one of an infrared communication device, a, preferably short range, radio frequency communication device, and an ultrasonic communication device. It will be appreciated that, alternatively, the second communication link 116 can be a conventional wired serial or parallel connection.

Briefly, in accordance with the present invention, the WIAD 102 determines a desired function to be performed by the intelligent device 112. For example, if the intelligent device is a video cassette recorder (VCR), the desired function to be performed could be “record channel 9 between 8:00 and 9:00 PM today.” A user preferably programs the desired function into the WIAD 102 through well-known menu selection and keypad entry techniques. The WIAD 102 advantageously does not have to be programmed in advance with the specific control instructions required by the brand of VCR to effect the desired function. Instead, the WIAD 102 identifies the VCR and the desired function to the web site 110 through the wireless communication network 104, the gateway 106, and the wired communication network 108. In response, the web site 110 returns to the WIAD a subset of control instructions accessible by or via the web site 110 for controlling the VCR to perform the desired function. In turn, the WIAD 102 forwards the subset of control instructions to the VCR to effect the desired function. In effect, the web site 110 brokers the control instructions to the WIAD for controlling the intelligent device 112 according to the desired function. Operation of the communication network 100 in accordance with the present invention will be described further herein below.

Referring to FIG. 2, an electrical block diagram of an exemplary intelligent device 112 in accordance with the present invention comprises a communication port 202 preferably for communicating a device identity to the WIAD 102 and for receiving control instructions from the WIAD 102. The communication port 202 can comprise, for example, a conventional infrared or ultrasonic transceiver, or a short-range RF transceiver using a well-known communication protocol, such as Bluetooth. It will be appreciated that, alternatively, the communication port 202 can comprise a conventional wired serial or parallel interface. It will be further appreciated that many existing intelligent devices have only receive capability in the communication port 202, and thus will be unable to transmit the device identity. In this case information regarding the intelligent device can be gathered and manually entered into WIAD 102. The communication port 202 is coupled to a conventional processor 204 for controlling the intelligent device 112. The intelligent device 112 also includes conventional functional elements 206 for performing predetermined functions under control of the processor 204. A predetermined function performed by a VCR, for example, is channel selection. The intelligent device 112 also includes a memory 208 comprising operating variables and software programs for programming the intelligent device 112 in accordance with the present invention. The memory 208 includes a communications program 210 for programming the processor 204 to perform the communications required in accordance with the present invention. In addition, the memory 208 includes a location for parameters or control instructions 212 received from the WIAD 102 through the communication port 202. The memory 208 also preferably includes a device description 214, which uniquely identifies the intelligent device 112 to the web site 110 via the WIAD 102, so that the appropriate control instructions can be determined.

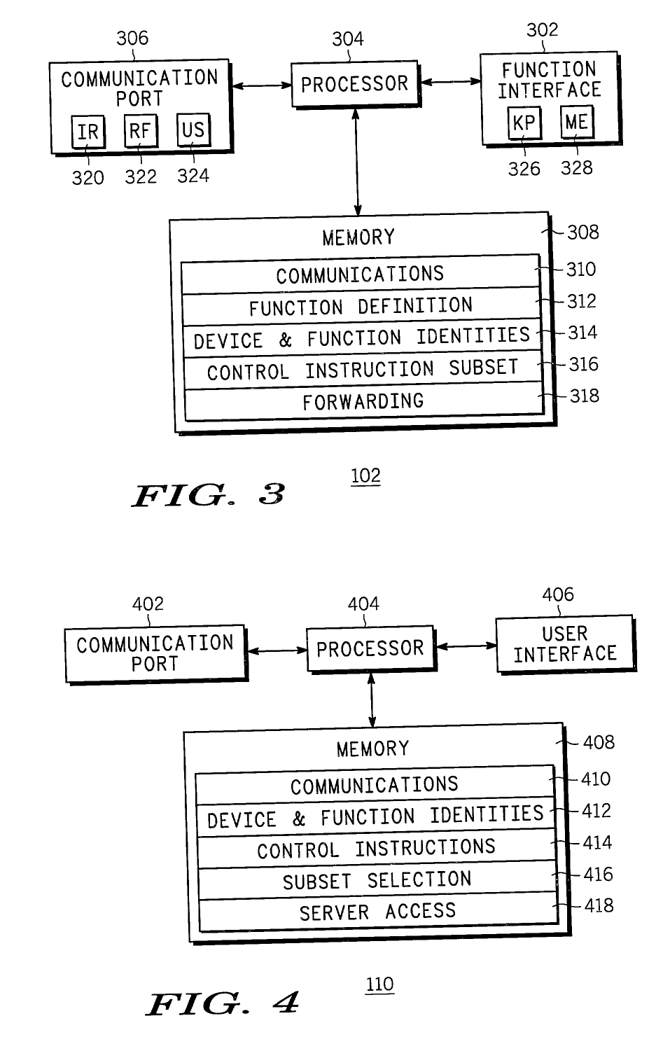

Referring to FIG. 3, an electrical block diagram of an exemplary wireless internet access device (WIAD) 102 in accordance with the present invention comprises a function interface 302 for defining a desired function to be performed by the intelligent device 112. The WIAD 102 further comprises a conventional processor 304 coupled to the function interface 302 for controlling the WIAD 102. The WIAD 102 also includes a communication port 306 coupled to the processor 304 for identifying the intelligent device 112 and the desired function to the web site 110 through the wireless communication network 104 and for receiving a response from the web site 110. The communication port 306 can, for example, comprise a conventional cellular telephone transceiver (not shown) utilizing a well-known communication protocol. In addition, the communication port 306 preferably comprises a conventional short-range communication element for communicating with the intelligent device 112. Examples of suitable short-range communication elements are an infrared transceiver 320, a short-range RF transceiver 322 (e.g., a Bluetooth transceiver), and an ultrasonic transceiver 324. It will be appreciated that, alternatively, the communication port 306 can comprise a conventional wired serial or parallel interface.

In one embodiment, the function interface 302 comprises a conventional keypad 326 through which a user can select the desired function through well-known techniques. In another embodiment, the function interface 302 comprises a measurement element 328, such as a conventional Global Positioning System (GPS) receiver for determining the geographic coordinates of the WIAD. The geographic coordinates can, for example, be used to program and align a motorized celestial telescope near the WIAD 102. In this case, the desired function is for the telescope to align itself based upon the geographic coordinates. In a third embodiment, the function interface 302 cooperates with the communication port 306 to communicate with the wireless communication network 104 to define the desired function. Continuing with the motorized telescope example, the wireless communication network 104 can determine the geographic coordinates of the WIAD through a well-known technique, such as triangulation. The wireless communication network 104 can then communicate the geographic coordinates to the WIAD through the communication port 306 to help define the desired function.

The WIAD 102 further comprises a memory 308 including operating variables and software for programming the processor 304 in accordance with the present invention. The memory 308 includes a communications program 310 for programming the processor 304 to communicate with appropriate elements of the communication network 100 and with the intelligent device 112 in accordance with the present invention. The memory 308 further comprises a function definition program 312 for programming the processor 304 to cooperate with at least one of the function interface 302 and the communication port 306 to define the desired function to be performed by the intelligent device 112. In addition, the memory 308 includes spaces for storing the identities 314 of the device (i.e., the device description 214) and the desired function, and the corresponding subset 316 of control instructions returned from the web site 110 and received by the WIAD 102. The memory also includes a forwarding program 318 for programming the processor 304 to forward the subset 316 of control instructions to the intelligent device 112 to effect the desired function.

Referring to FIG. 4, an electrical block diagram of an exemplary web site 110 in accordance with the present invention comprises a communication port 402 for communicating with the WIAD 102 through portions of the communication network 100, using well-known communication techniques. The web site 110 further comprises a conventional processor 404 coupled to the communication port 402 for controlling the web site 110. The web site 110 also includes a conventional user interface 406 coupled to the processor 404 for programming and controlling the web site 110. The web site 110 also includes a memory 408 comprising operating variables and software for programming the processor 404 in accordance with the present invention.

The memory 408 includes a communications program 410 for programming the processor 404 to communicate with appropriate elements of the communication network 100 and with the WIAD 102 in accordance with the present invention. The memory 408 further comprises space for storing device and function identities 412 received from the WIAD 102 for identifying the intelligent device 112 and the desired function to be performed by the intelligent device 112. The memory 408 also includes control instructions 414 for controlling the intelligent device 112. The control instructions 414 are preferably pre-programmed into the memory 408. Alternatively, the control instructions 414 (or a subset thereof) can be downloaded from a conventional server (not shown) operated, for example, by the manufacturer of the intelligent device 112. The memory 408 further comprises a subset selection program 416 for selecting a subset of the control instructions 414, the subset corresponding to those instructions necessary for performing the desired function. In addition, the web site 110 includes a server access program 418 for accessing a server having the control instructions to download the subset of the control instructions before forwarding the subset to the WIAD 102, and thence to the intelligent device 112.

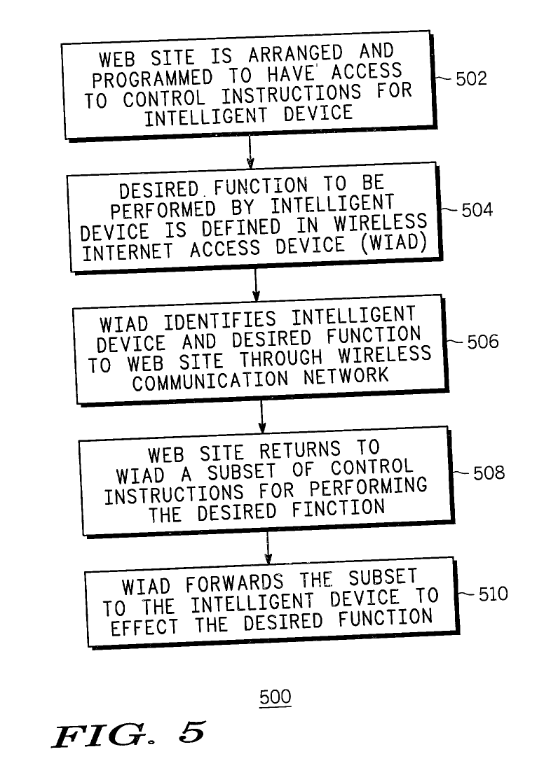

Referring to FIG. 5, a flow diagram 500 depicts operation of the exemplary communication network 100 in accordance with the present invention. The flow begins with arranging and programming 502 the web site 110 to have access to the control instructions 414 for the intelligent device 112. Two access methods are envisioned: (a) the control instructions 414 can be pre-programmed into the memory 408 of the web site 110, and (b) the control instructions (or a subset thereof) can be accessed and downloaded by the web site 110 when needed, from a server having the control instructions pre-programmed therein.

Next, the desired function to be performed by the intelligent device 112 is defined 504 in the WIAD 102, as described herein above. The WIAD 102 then identifies 506 the intelligent device 112 and the desired function to the web site 110 through the wireless communication network 104, the gateway 106, and the wired communication network 108. It will be appreciated that, alternatively, the web site 110 can be coupled directly to the wireless communication network 104, without utilizing the gateway 106 and the wired communication network 108. In that embodiment, it is to be understood that the web site 110, while similar in function to an Internet web site, is not necessarily required to be coupled to either the Internet or the World Wide Web. It will be further appreciated that the WIAD 102 may have to communicate with the intelligent device 112 to obtain the device description 214 before performing step 506, when the WIAD 102 has not previously obtained the device description 214. Alternatively, if the intelligent device 112 does not have transmit capability, the user can enter the device description, e.g., manufacturer and model number, directly into the WIAD 102 through the keypad 326.

In any event, the web site 110 then returns 508 to the WIAD 102 a subset 316 of the control instructions 414 for performing the identified desired function on the identified intelligent device 112. In response, the WIAD 102 forwards 510 the subset 316 of the control instructions 414 to the intelligent device 112 to effect the desired function. Operating in the manner just described, the present invention advantageously enables the WIAD 102 to control an unlimited number of different intelligent devices 112, including new intelligent devices that become available after the WIAD has been manufactured and placed into service. In addition, the present invention minimizes the amount of memory required in the WIAD for storing control instructions.

It should be clear from the preceding disclosure that the present invention provides a method and apparatus for brokering of control instructions for an intelligent device. Advantageously, the method and apparatus simplifies setup and control of intelligent devices by a user. In addition, the method and apparatus requires little memory and provides for automatic updating of control instructions as new intelligent devices become available on the market.

Many modifications and variations of the present invention are possible in light of the above teachings. Thus, it is to be understood that, within the scope of the appended claims, the invention can be practiced other than as described herein above.

1. A method for command brokering on behalf of an intelligent device, comprising the steps of:
defining in a wireless internet access device (WIAD) a desired function to be performed by the intelligent device;
identifying the intelligent device and the desired function to a web site having access to control instructions for the intelligent device by the WIAD, through a wireless communication network;
returning, to the WIAD from the web site, a subset of the control instructions for controlling the intelligent device to perform the desired function; and
forwarding the subset of the control instructions from the WIAD to the intelligent device to effect the desired function.

2. The method of claim 1, wherein the forwarding step comprises the step of forwarding the subset through an infrared communication device.

3. The method of claim 1, wherein the forwarding step comprises the step of forwarding the subset through a radio frequency communication device.

4. The method of claim 1, wherein the forwarding step comprises the step of forwarding the subset through an ultrasonic communication device.

5. The method of claim 1, wherein the defining step comprises the step of defining said desired function through a user keypad entry.

6. The method of claim 1, wherein the defining step comprises the step of defining said desired function through a measurement made by the WIAD.

7. The method of claim 1, wherein the defining step comprises the step of defining said desired function through a measurement made by the wireless communication network.

8. The method of claim 1, further including the step of arranging for the web site to have access to the control instructions by pre-programming the control instructions into a memory of the web site.

9. The method of claim 1, further including a step of arranging for the web site to have access to the control instructions by the web site accessing a server having the control instructions for controlling the intelligent device.

10. The method of claim 1,
wherein the intelligent device comprises a motorized celestial telescope, and
wherein the defining step comprises the step of determining geographic coordinates corresponding to a position of the WIAD.

11. A wireless internet access device (WIAD) for performing command brokering on behalf of an intelligent device through a wireless communication network coupled to a web site having access to control instructions for the intelligent device, the WIAD comprising:
a function interface for defining a desired function to be performed by the intelligent device;
a processor coupled to the function interface for controlling the WIAD; and
a communication port coupled to the processor for identifying the intelligent device and the desired function to the web site through the wireless communication network and for receiving a response from the web site,
wherein the processor is programmed to
receive from the web site a subset of the control instructions for controlling the intelligent device to perform the desired function; and
forward the subset of the control instructions from the WIAD to the intelligent device to effect the desired function.

12. The WIAD of claim 11,
wherein the communication port comprises an infra-red communication device, and
wherein the processor is further programmed to forward the subset through the infrared communication device.

13. The WIAD of claim 11,
wherein the communication port comprises a radio frequency communication device, and
wherein the processor is further programmed to forward the subset through the radio frequency communication device.

14. The WIAD of claim 11,
wherein the communication port comprises an ultrasonic communication device, and
wherein the processor is further programmed to forward the subset through the ultrasonic communication device.

15. The WIAD of claim 11, wherein the function interface comprises a keypad.

16. The WIAD of claim 11, wherein the function interface comprises a measurement element.

17. The WIAD of claim 11, wherein the function interface is arranged to cooperate with the wireless communication port for communicating with the wireless communication network to define the desired function.

18. A web site for facilitating command brokering on behalf of an intelligent device through a wireless communication network via a wireless internet access device (WIAD), the web site comprising:
a communication port for communicating with the WIAD; and
a processor coupled to the communication port for controlling the web site,
wherein the processor is arranged and programmed to
access control instructions for the intelligent device;
receive from the WIAD an identification of the intelligent device and a desired function to be performed by the intelligent device; and
return a subset of the control instructions to the WIAD for forwarding to the intelligent device to effect the desired function.

19. The web site of claim 18, further comprising a memory pre-programmed with the control instructions.

20. The web site of claim 18, wherein the processor is programmed to access a server having the control instructions for controlling the intelligent device.
